(19) United States
(12) Patent Application Publication
(10) Pub. No.: US 2025/0247025 A1
(43) Pub. Date: Jul. 31, 2025

(54) MOTIVE POWER SYSTEM FOR ELECTRIC VEHICLE, AND ELECTRIC VEHICLE COMPRISING SAME

(71) Applicant: VALEO EAUTOMOTIVE FRANCE SAS, Cergy (FR)

(72) Inventor: Ye Jin JIN, Cergy (FR)

(73) Assignee: VALEO EAUTOMOTIVE FRANCE SAS, Cergy (FR)

(21) Appl. No.: 18/855,611

(22) PCT Filed: Apr. 11, 2023
(86) PCT No.: PCT/EP2023/059387

§ 371 Date: Oct. 9, 2024

(30) Foreign Application Priority Data
Apr. 11, 2022 (CN) 202210374487.4

(51) Int. Cl. H02P 5/50; B60K 1/02; B60L 15/20

(52) U.S. Cl. CPC H02P 5/50; B60K 1/02; B60L 15/20; B60L 2220/14

(57) ABSTRACT

A motive power system for an electric vehicle includes a permanent magnet synchronous motor and an electrically excited synchronous motor, one of which being a front drive electric machine for driving front wheels of the electric vehicle, and the other of which being a rear drive electric machine for driving rear wheels of the electric vehicle. A peak power and a peak torque of the permanent magnet synchronous motor are less than a peak power and a peak torque of the electrically excited synchronous motor. The powers outputted by the permanent magnet synchronous motor and the electrically excited synchronous motor are dynamically adjusted according to real-time operating conditions of the electric vehicle, such that a power loss sustained by the motive power system reaches a predetermined minimum value.

### TECHNICAL FIELD

The present disclosure relates to a motive power system for an electric vehicle. In particular, the motive power system comprises a permanent magnet synchronous motor (PSM) and an electrically excited synchronous motor (EESM). The present disclosure further relates to an electric vehicle comprising such a motive power system.

### BACKGROUND

Motor vehicle electrification is an important means of enabling the transport industry to deal with climate change and achieve carbon neutrality. In recent years, the penetration rate of electric vehicles has increased considerably in all major markets. Compared with the internal combustion engines used in fuel vehicles, the electric motors used in electric vehicles have unique motive power characteristics. In general, electric vehicles have good driveability, being capable of faster start-up speed as well as high efficiency at low speed, so are especially well-suited to urban commuting scenarios where frequent starting and stopping is required and speeds are relatively low. However, in scenarios requiring higher power and torque, such as sharp acceleration and high-speed cruising, the advantages of electric vehicles are no longer so pronounced. One feasible solution to this is a four-wheel-drive electric vehicle, driven by four wheels and realized using two electric machines.

The two electric machines of a four-wheel-drive electric vehicle are generally a main drive electric machine and an auxiliary drive electric machine, wherein the auxiliary drive electric machine may be in a non-operational state in some situations. In existing four-wheel-drive electric vehicles, the main drive electric machine is usually a permanent magnet synchronous motor, while the auxiliary drive electric machine may be an asynchronous induction motor (ASM) or a permanent magnet synchronous motor. However, permanent magnet synchronous motors are expensive, with high drag loss, and consequently have relatively high power loss at low loads. If a high-power permanent magnet synchronous motor is used as the main drive electric machine, then efficiency cannot be increased under everyday driving conditions at low loads. If a low-power permanent magnet synchronous motor is used as the main drive electric machine, then the asynchronous induction motor used as the auxiliary drive electric machine must have a higher power to meet the total power requirement, but high-power asynchronous induction motors are large in volume and exhibit a serious drop in power and torque at high rotation speeds, resulting in lower overall efficiency. If both the main drive electric machine and the auxiliary drive electric machine are permanent magnet synchronous motors, then the auxiliary drive permanent magnet synchronous motor must be able to be disconnected from the electric vehicle's motive power system by means of a disengagement unit such as a clutch when not operational, otherwise a back emf will arise due to the fact that the rotor magnetic field follows in rotation, causing a large loss of power, and possibly having an adverse effect on the electric machine control unit. Such a disengagement unit will cause costs to rise, and when the auxiliary drive permanent magnet synchronous motor is required to operate, it can only be connected to the electric vehicle's motive power system after accelerating the rotor to match the speed of the electric vehicle. This can cause a motive power delay of as much as 500 ms, causing a decline in the driving performance of the electric vehicle.

Thus, due to electric machine characteristics, existing dual-electric-machine solutions for electric vehicles have many issues, and cannot attend to both driving performance and efficiency of an electric vehicle at the same time at a low cost.

### SUMMARY

An objective of the present disclosure is to propose a motive power system for an electric vehicle to solve the abovementioned technical problems, the motive power system having a low cost, excellent driving performance and high efficiency.

The motive power system for an electric vehicle according to the present disclosure comprises a permanent magnet synchronous motor and an electrically excited synchronous motor. One of the permanent magnet synchronous motor and electrically excited synchronous motor is a front drive electric machine for driving front wheels of the electric vehicle, and the other of the permanent magnet synchronous motor and electrically excited synchronous motor is a rear drive electric machine for driving rear wheels of the electric vehicle. A peak power and a peak torque of the permanent magnet synchronous motor are less than a peak power and a peak torque of the electrically excited synchronous motor. The powers outputted by the permanent magnet synchronous motor and the electrically excited synchronous motor are dynamically adjusted according to real-time operating conditions of the electric vehicle, such that a power loss sustained by the motive power system reaches a predetermined minimum value.

In the present disclosure, the motive power system for an electric vehicle uses a permanent magnet synchronous motor with a lower relative power and an electrically excited synchronous motor with a higher relative power. Thus, the permanent magnet synchronous motor has a reduced cost and can operate in a high-load region, the drag loss is low and efficiency is higher. Compared with an asynchronous induction motor of the same power, the electrically excited synchronous motor has a smaller volume and a higher efficiency. In addition, with the electrically excited synchronous motor, the excitation current can be switched on or off to control whether the rotor generates a magnetic field. Thus, when the electrically excited synchronous motor is not required to output motive power, the excitation current can be cut off, and the rotor can then follow in rotation without generating a back emf, thus reducing the power loss. For this reason, the electric vehicle using the electrically excited synchronous motor need not be equipped with a disengagement unit, so costs are reduced. Due to the fact that the rotor follows in rotation, there is no need to re-match the rotor's rotation speed when the electrically excited synchronous motor is brought into use, so the motive power delay is considerably reduced, and there will not be a decline in driving performance of the electric vehicle. Moreover, the powers outputted by the permanent magnet synchronous motor and electrically excited synchronous motor are dynamically adjusted so that the power loss sustained by the motive power system reaches a predetermined minimum value, so the efficiency of the electric vehicle can be further improved. Thus, the motive power system for an electric vehicle according to the present disclosure has a lower cost, and at the same time has excellent driving performance and higher efficiency.

The rotor according to the present disclosure may also have one or more of the following features, separately or in combination.

According to an embodiment of the present disclosure, the permanent magnet synchronous motor outputs a first power P1, and the electrically excited synchronous motor outputs a second power P2, wherein the first power P1, the second power P2, and a required power P required by real-time operating conditions of the electric vehicle, satisfy P1+P2=P. The motive power system sustains a first power loss PL1 associated with the permanent magnet synchronous motor when the permanent magnet synchronous motor outputs the first power P1, and the motive power system sustains a second power loss PL2 associated with the electrically excited synchronous motor when the electrically excited synchronous motor outputs the second power P2. The ratio R of the first power P1 to the required power P is dynamically adjusted according to real-time operating conditions of the electric vehicle, such that the sum of the first power loss PL1 and second power loss PL2 reaches a predetermined minimum value.

According to an embodiment of the present disclosure, the first power loss PL1 comprises a drag power loss arising in the permanent magnet synchronous motor, and a power loss associated with the permanent magnet synchronous motor and arising in a transmission system and an inverter of the electric vehicle, and the second power loss PL2 comprises a drag power loss arising in the electrically excited synchronous motor, and a power loss associated with the electrically excited synchronous motor and arising in a transmission system and an inverter of the electric vehicle.

According to an embodiment of the present disclosure, the permanent magnet synchronous motor is used as the front drive electric machine, and the electrically excited synchronous motor is used as the rear drive electric machine.

According to an embodiment of the present disclosure, when the electric vehicle is operating under NEDC operating conditions, CLTC operating conditions and/or WLTP operating conditions, the required power P required by real-time operating conditions of the electric vehicle is outputted by the permanent magnet synchronous motor alone, such that the first power P1=P and the second power P2=0.

According to an embodiment of the present disclosure, when the electric vehicle accelerates sharply or is cruising at high speed, the required power P required by real-time operating conditions of the electric vehicle is outputted by the permanent magnet synchronous motor and electrically excited synchronous motor together, such that the first power P1, the second power P2 and the required power P satisfy the following relations: 0<P1<P, 0<P2<P, and P1+P2=P.

According to an embodiment of the present disclosure, the peak power of the permanent magnet synchronous motor is 60 kW-150 KW, and the peak power of the electrically excited synchronous motor is 150 KW-300 kW.

The present disclosure further relates to an electric vehicle, comprising a control system and the motive power system. The control system acquires real-time operating conditions of the electric vehicle, and dynamically adjusts the powers outputted by the permanent magnet synchronous motor and the electrically excited synchronous motor.

According to an embodiment of the present disclosure, the control system comprises a memory, for storing a predetermined mapping or model between real-time operating conditions of the electric vehicle and the ratio R, and the control system dynamically adjusts the ratio R by querying the predetermined mapping or model.

### BRIEF DESCRIPTION OF THE DRAWINGS

The abovementioned and other features and advantages of the present disclosure will become more obvious through the following detailed description of exemplary embodiments in conjunction with the drawings. Moreover, this description and the drawings merely serve an exemplary purpose and do not limit the scope of the present disclosure in any way. In the drawings:

FIG. 1 shows a block diagram of a motive power system for an electric vehicle according to an embodiment of the present disclosure.

FIG. 2 shows a schematic diagram of energy transmission in the motive power system.

### DETAILED DESCRIPTION

In order to clarify the objective, technical solution and advantages of embodiments of the present disclosure, the technical solution of embodiments of the present disclosure is described clearly and completely below in conjunction with the drawings accompanying embodiments of the present disclosure.

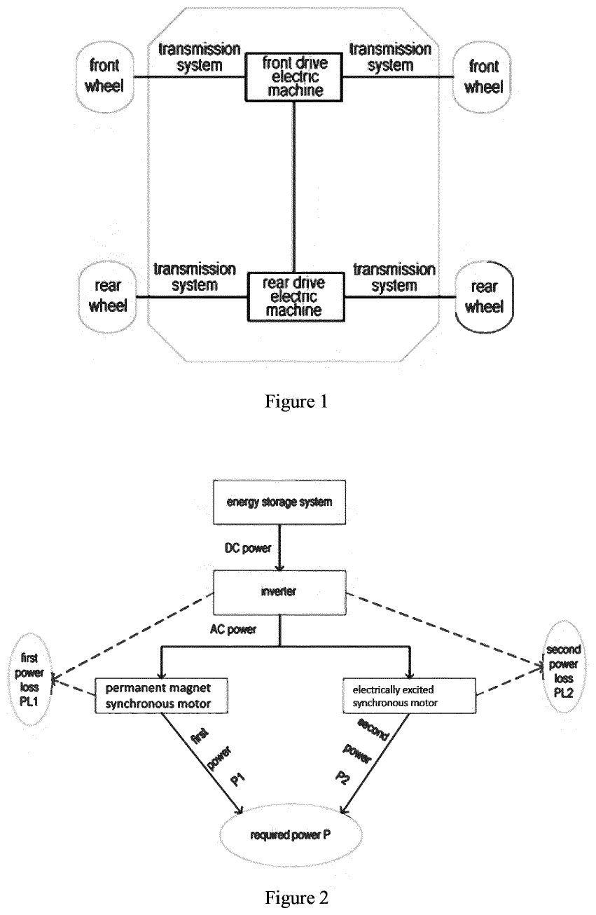

Unless otherwise defined, technical terms or scientific terms used herein shall have the common meanings understood by those skilled in the art. “One”, “a” or “said” and similar words used in the description and claims of the patent application of the present disclosure do not indicate a quantity limit, but mean that there is at least one. “Comprises” or “includes” and similar words mean that the element or object appearing before the word encompasses the elements or objects and their equivalents listed after the word, without excluding other elements or objects. “Efficiency” means the ratio of the power outputted by the motive power system and components thereof to the power consumed thereby; consumed power=output power+power loss, so efficiency=output power/(output power+power loss). In particular, for the motive power system as a whole, the output power is the power required by the electric vehicle under corresponding operating conditions, so the efficiency of the motive power system=required power/(required power+power loss). FIG. 1 shows a block diagram of a motive power system for an electric vehicle according to an embodiment of the present disclosure. The motive power system comprises a front drive electric machine for driving the front wheels of the electric vehicle, and a rear drive electric machine for driving the rear wheels of the electric vehicle. The front drive electric machine and rear drive electric machine are each one selected from a permanent magnet synchronous motor and an electrically excited synchronous motor.

The rotor of a permanent magnet synchronous motor generates a magnetic field by means of fitted permanent magnets, so does not need to consume energy to generate the rotor magnetic field, and thus has very high efficiency. However, to increase a peak power and a peak torque of a permanent magnet synchronous motor, the number of permanent magnets on the rotor must be increased, so the cost is higher. Moreover, when the rotor of a permanent magnet synchronous motor rotates, the magnetic field of the permanent magnet will generate drag resistance, hindering rotor rotation. The magnetic field of the rotor's permanent magnets is constant, so the drag loss caused by the drag resistance cannot be reduced in the same proportion even at low loads; as a result, a permanent magnet synchronous motor has relatively high drag power loss at low loads, and reduced efficiency. Moreover, because the magnetic field of the rotor's permanent magnets is constant, the rotating rotor can generate drag resistance and generate a back emf in the stator coils even when the permanent magnet synchronous motor is not operating. This drag resistance can be used as a braking force for the electric vehicle, while the back emf can charge the battery of the electric vehicle, thus achieving energy recovery for the electric vehicle.

The rotor of an electrically excited synchronous motor does not comprise any magnets, or comprise only a very small number of magnets, so must rely on an excitation current to generate a magnetic field. Thus, a peak power and a peak torque of an electrically excited synchronous motor can be increased by increasing the number of excitation coils and increasing the excitation current; the costs required are relatively low, and the increased volume is smaller than an asynchronous induction motor. At low loads, the rotor magnetic field can be reduced by reducing the excitation current; the drag power loss can thereby be reduced, and there will not be any obvious drop in efficiency. When the electrically excited synchronous motor is not operating, the excitation current may be cut off so that the rotor has no magnetic field; the rotor can then follow in rotation, and no resistance will arise due to rotor magnetic field. Thus, an electric vehicle that uses an electrically excited synchronous motor need not be equipped with a disengagement unit such as a clutch, so costs are reduced. Furthermore, because the rotor of an electrically excited synchronous motor follows in rotation, the rotation speed thereof is matched to a real-time speed of the electric vehicle, and there is no need to accelerate the rotor again when the electrically excited synchronous motor needs to be brought into use again, so the motive power delay time is reduced.

In view of the abovementioned characteristics of permanent magnet synchronous motors and electrically excited synchronous motors, the motive power system according to the present disclosure uses a relatively small permanent magnet synchronous motor and a relatively large electrically excited synchronous motor, wherein a peak power and a peak torque of the permanent magnet synchronous motor are strictly less than a peak power and a peak torque of the electrically excited synchronous motor. This arrangement allows the permanent magnet synchronous motor to operate at high loads as much as possible, thus reducing the effect of drag power loss on efficiency, while also reducing the cost of the permanent magnet synchronous motors. The electrically excited synchronous motor with higher peak power and peak torque can meet the power requirements of the electric vehicle during sharp acceleration or high-speed cruising. In particular, the peak power of the permanent magnet synchronous motor is 60 kW-150 KW, and the peak power of the electrically excited synchronous motor is 150 kW-300 kW. Furthermore, taking into account driving demands in the course of everyday travel and the requirement for the permanent magnet synchronous motor to recover energy for the electric vehicle, preferably, the permanent magnet synchronous motor is used as the front drive electric machine and the electrically excited synchronous motor is used as the rear drive electric machine. As can be envisaged, depending on different needs, it is also possible for the electrically excited synchronous motor to be used as the front drive electric machine, while the permanent magnet synchronous motor is used as the rear drive electric machine.

The inventors of the present application have simulated two types of motor arrangement. Motor arrangement 1 used a combination of a permanent magnet synchronous motor with a peak power of 80 kW and an electrically excited synchronous motor with a peak power of 150 kW; motor arrangement 2 used a combination of a permanent magnet synchronous motor with a peak power of 80 kW and a permanent magnet synchronous motor with a peak power of 150 kW. The simulation results are shown in Table 1 below. As can be seen, when the combination of the permanent magnet synchronous motor and the electrically excited synchronous motor is used, the power loss arising in the motive power system is reduced in comparison with the combination of two permanent magnet synchronous motors in both urban operating conditions and high-speed operating conditions, and this reduction is especially pronounced in high-speed operating conditions.

TABLE 1
Power losses in motive power systems with different motor arrangements
in urban operating conditions and high-speed operating conditions

| | | | | | Transmission system | | Motive power system | |
|---|---|---|---|---|---|---|---|---|
| | Inverter power loss (W) | | Motor power loss (W) | | power loss (W) | | power loss (W) | |
| Operating | Motor | Motor | Motor | Motor | Motor | Motor | Motor | Motor |
| conditions | arrangement 1 | arrangement 2 | arrangement 1 | arrangement 2 | arrangement 1 | arrangement 2 | arrangement 1 | arrangement 2 |
| Urban | 226 | 221 | 431 | 424 | 172 | 224 | 830 | 870 |
| High speed | 123 | 143 | 465 | 887 | 262 | 354 | 851 | 1385 |

FIG. 2 shows a schematic diagram of energy transmission in the motive power system. Referring to FIG. 2, an energy storage system of the electric vehicle (such as a power battery or fuel cell, etc.) outputs electric power in DC form, which, after conversion in an inverter, is outputted to the motive power system and powers the permanent magnet synchronous motor and electrically excited synchronous motor. The permanent magnet synchronous motor outputs a first power P1, and the electrically excited synchronous motor outputs a second power P2, the sum of these two powers being the required power P that is required by real-time operating conditions of the electric vehicle, i.e. P1+P2=P.

When the permanent magnet synchronous motor outputs the first power P1, the motive power system sustains a first power loss PL1 associated therewith—for example, a power loss in the inverter, which power loss is associated with the permanent magnet synchronous motor; a drag power loss arising in the permanent magnet synchronous motor; a power loss arising in the transmission system, which power loss is associated with the permanent magnet synchronous motor; and so on. Similarly, when the electrically excited synchronous motor outputs the second power P2, the motive power system sustains a second power loss PL2 associated therewith—for example, a power loss in the inverter, which power loss is associated with the electrically excited synchronous motor; a drag power loss arising in the electrically excited synchronous motor; a power loss arising in the transmission system, which power loss is associated with the electrically excited synchronous motor; and so on. Such power losses result in the electric vehicle having increased energy consumption and a reduced range. For this reason, it is hoped that such power losses can be reduced as far as possible.

To this end, the powers outputted by the permanent magnet synchronous motor and the electrically excited synchronous motor may be dynamically adjusted by a control system of the electric vehicle. The criterion for this dynamic adjustment is to make the power loss sustained by the motive power system of the electric vehicle reach a predetermined minimum value. Specifically, the control system can continuously acquire real-time operating conditions of the electric vehicle, such as vehicle travel speed, road conditions, electric machine torque, etc. Based on these real-time operating conditions, the control system can confirm the current required power P of the electric vehicle, control the permanent magnet synchronous motor to output the first power P1 and the electrically excited synchronous motor to output the second power P2 such that P1+P2=P, and adjust the ratio R of the first power P1 to the required power P such that the sum of the first power loss PL1 and the second power loss PL2 reaches a predetermined minimum value.

The efficiency of the permanent magnet synchronous motor is generally higher than that of the electrically excited synchronous motor, so in some situations, especially when the power and torque of the permanent magnet synchronous motor can meet the requirements of real-time operating conditions of the electric vehicle, the required power P may be outputted by the permanent magnet synchronous motor alone, while the electrically excited synchronous motor follows in rotation, i.e. the first power P1=P, and the second power P2=0. For example, when the electric vehicle is operating under NEDC operating conditions, CLTC operating conditions and/or WLTP operating conditions, the required power P is outputted by the permanent magnet synchronous motor alone, and a higher range can be achieved.

When the requirements of real-time operating conditions of the electric vehicle exceed the peak power and peak torque of the permanent magnet synchronous motor, for example when the electric vehicle accelerates sharply or is cruising at high speed, the electrically excited synchronous motor is brought into use, and the required power P required by real-time operating conditions of the electric vehicle is outputted by the permanent magnet synchronous motor and the electrically excited synchronous motor together. At this time, the first power P1, the second power P2 and the required power P satisfy the following relations: 0<P1<P, 0<P2<P, and P1+P2=P. The ratio R of the first power P1 to the required power P is dynamically adjusted by means of the control system, such that the sum of the first power loss PL1 and the second power loss PL2 reaches a predetermined minimum value.

For a specific operating condition of the electric vehicle, the ratio R of the first power P1 to the required power P which causes the sum of the first power loss PL1 and the second power loss PL2 to reach a predetermined minimum value may be determined through a test. Table 2 and Table 3 below show the power losses (W) produced by different ratios R in specific urban operating conditions and specific high-speed operating conditions.

TABLE 2
Power losses produced by different ratios R in
specific urban operating conditions

| | | | | | PL1 + PL2 |
|---|---|---|---|---|---|
| Ratio R | P1 (kW) | P2 (kW) | PL1 (kW) | PL2 (kW) | (kW) |
| 0 | 0 | 40 | 2 | 16 | 18 |
| 0.2 | 8 | 32 | 4.8 | 11.2 | 16 |
| 0.4 | 16 | 24 | 6.8 | 7.2 | 14 |
| 0.6 | 24 | 16 | 8.48 | 4.32 | 12.8 |
| 0.8 | 32 | 8 | 11.28 | 2.32 | 13.6 |
| 1 | 40 | 0 | 14.4 | 0.5 | 14.9 |

TABLE 3
Power losses produced by different ratios R in specific
high-speed operating conditions

| | | | | | PL1 + PL2 |
|---|---|---|---|---|---|
| Ratio R | P1 (kW) | P2 (kW) | PL1 (kW) | PL2 (kW) | (kW) |
| 0 | 0 | 50 | 3.5 | 7.5 | 11 |
| 0.2 | 10 | 40 | 4.9 | 5.6 | 10.5 |
| 0.4 | 20 | 30 | 6.1 | 3.9 | 10 |
| 0.6 | 30 | 20 | 7.1 | 2.4 | 9.5 |
| 0.8 | 40 | 10 | 8.1 | 1.15 | 9.25 |
| 1 | 50 | 0 | 8.5 | 0.5 | 9 |

It can be determined from Table 2 and Table 3 above that in the corresponding specific operating conditions, the ratios R which cause the sum of the first power loss PL1 and the second power loss PL2 to reach a predetermined minimum value are 0.6 and 1.0, respectively. Similarly, the abovementioned ratio R may be determined for various operating conditions that the electric vehicle might experience. That is to say, a mapping between real-time operating conditions of the electric vehicle and the ratio R may be predetermined. The control system of the electric vehicle comprises a memory, in which the predetermined mapping may be stored. As the electric vehicle is travelling, the control system dynamically adjusts the ratio R by querying the predetermined mapping. Optionally, a model between real-time operating conditions of the electric vehicle and the ratio R may also be predetermined, and stored in the memory of the control system. As the electric vehicle is travelling, the control system dynamically adjusts the ratio R by querying the predetermined model. Certain features, structures or characteristics in one or more embodiments of the present disclosure may be combined appropriately.

The above is a description of the present disclosure, and should not be regarded as limiting it. Although some exemplary embodiments of the present disclosure have been described, those skilled in the art will readily understand that many modifications could be made to the exemplary embodiments without departing from the original teaching and advantages of the present disclosure. Therefore, all such modifications are intended to be included in the scope of the present disclosure as defined by the claims. It should be understood that the above is a description of the present disclosure, and the present disclosure should not be regarded as being limited to the specific embodiments disclosed; moreover, modifications to the disclosed embodiments and other embodiments are intended to be included in the scope of the present disclosure.

1. A motive power system for an electric vehicle, comprising a permanent magnet synchronous motor and an electrically excited synchronous motor, one of the permanent magnet synchronous motor and electrically excited synchronous motor being a front drive electric machine for driving front wheels of the electric vehicle, and the other of the permanent magnet synchronous motor and electrically excited synchronous motor being a rear drive electric machine for driving rear wheels of the electric vehicle,
wherein a peak power and a peak torque of the permanent magnet synchronous motor are less than a peak power and a peak torque of the electrically excited synchronous motor, and
wherein the powers outputted by the permanent magnet synchronous motor and the electrically excited synchronous motor are dynamically adjusted according to real-time operating conditions of the electric vehicle, such that a power loss sustained by the motive power system reaches a predetermined minimum value.

2. The motive power system according to claim 1, wherein
the permanent magnet synchronous motor outputs a first power P1, and the electrically excited synchronous motor outputs a second power P2, wherein the first power P1, the second power P2, and a required power P required by real-time operating conditions of the electric vehicle, satisfy P1+P2=P,
the motive power system sustains a first power loss PL1 associated with the permanent magnet synchronous motor when the permanent magnet synchronous motor outputs the first power P1, and the motive power system sustains a second power loss PL2 associated with the electrically excited synchronous motor when the electrically excited synchronous motor outputs the second power P2,
wherein the ratio R of the first power P1 to the required power P is dynamically adjusted according to real-time operating conditions of the electric vehicle, such that the sum of the first power loss PL1 and second power loss PL2 reaches a predetermined minimum value.

3. The motive power system according to claim 2, wherein the first power loss PL1 comprises a drag power loss arising in the permanent magnet synchronous motor, and a power loss associated with the permanent magnet synchronous motor and arising in a transmission system and an inverter of the electric vehicle, and
the second power loss PL2 comprises a drag power loss arising in the electrically excited synchronous motor, and a power loss associated with the electrically excited synchronous motor and arising in a transmission system and an inverter of the electric vehicle.

4. The motive power system according to claim 1, wherein the permanent magnet synchronous motor is used as the front drive electric machine, and the electrically excited synchronous motor is used as the rear drive electric machine.

5. The motive power system according to claim 2, wherein when the electric vehicle is operating under NEDC operating conditions, CLTC operating conditions and/or WLTP operating conditions, the required power P required by real-time operating conditions of the electric vehicle is outputted by the permanent magnet synchronous motor alone, such that the first power P1=P and the second power P2=0.

6. The motive power system according to claim 2, wherein when the electric vehicle accelerates sharply or is cruising at high speed, the required power P required by real-time operating conditions of the electric vehicle is outputted by the permanent magnet synchronous motor and electrically excited synchronous motor together, such that the first power P1, the second power P2 and the required power P satisfy the following relations: 0<P1<P, 0<P2<P, and P1+P2=P.

7. The motive power system according to claim 1, wherein the peak power of the permanent magnet synchronous motor is from 60 kW to 150 KW, and the peak power of the electrically excited synchronous motor is from 150 kW to 300 kW.

8. An electric vehicle, comprising a control system and the motive power system according to claim 1,
wherein the control system acquires real-time operating conditions of the electric vehicle, and dynamically adjusts the powers outputted by the permanent magnet synchronous motor and the electrically excited synchronous motor.

9. An electric vehicle according to claim 8, wherein the control system comprises a memory, for storing a predetermined mapping or model between real-time operating conditions of the electric vehicle and the ratio R, and the control system dynamically adjusts the ratio R by querying the predetermined mapping or model.

10. An electric vehicle, comprising a control system and the motive power system according to claim 2,
wherein the control system acquires real-time operating conditions of the electric vehicle, and dynamically adjusts the powers outputted by the permanent magnet synchronous motor and the electrically excited synchronous motor.

11. An electric vehicle, comprising a control system and the motive power system according to claim 3,
wherein the control system acquires real-time operating conditions of the electric vehicle, and dynamically adjusts the powers outputted by the permanent magnet synchronous motor and the electrically excited synchronous motor.

12. An electric vehicle, comprising a control system and the motive power system according to claim 4,
wherein the control system acquires real-time operating conditions of the electric vehicle, and dynamically adjusts the powers outputted by the permanent magnet synchronous motor and the electrically excited synchronous motor.

13. An electric vehicle, comprising a control system and the motive power system according to claim 5,
wherein the control system acquires real-time operating conditions of the electric vehicle, and dynamically adjusts the powers outputted by the permanent magnet synchronous motor and the electrically excited synchronous motor.

14. An electric vehicle, comprising a control system and the motive power system according to claim 6,
wherein the control system acquires real-time operating conditions of the electric vehicle, and dynamically adjusts the powers outputted by the permanent magnet synchronous motor and the electrically excited synchronous motor.

15. An electric vehicle, comprising a control system and the motive power system according to claim 7,
wherein the control system acquires real-time operating conditions of the electric vehicle, and dynamically adjusts the powers outputted by the permanent magnet synchronous motor and the electrically excited synchronous motor.
